(19) United States
(12) Patent Application Publication
(10) Pub. No.: US 2017/0220752 A1
(43) Pub. Date: Aug. 3, 2017

(54) SYSTEMS AND METHODS FOR PROBABILISTIC PULSE RATE ESTIMATION FROM PHOTOPLETHYSMOGRAPHIC MEASUREMENTS IN THE PRESENCE OF NONSTATIONARY AND NONTRIVIAL SIGNAL AND NOISE SPECTRA

(71) Applicant: Verily Life Sciences LLC, Mountain View, CA (US)

(72) Inventors: Mark Murphy, Mountain View, CA (US); Christopher T. Lengerich, Palo Alto, CA (US); Russell N. Mirov, Los Altos, CA (US)

(73) Assignee: Verily Life Sciences LLC

(21) Appl. No.: 15/421,242

(22) Filed: Jan. 31, 2017

Related U.S. Application Data
(60) Provisional application No. 62/289,781, filed on Feb. 1, 2016.

(51) Int. Cl. G06F 19/00; G06N 99/00; G06N 5/04; G06N 7/00

(52) U.S. Cl. CPC G06F 19/345; G06N 7/005; G06N 99/005; G06N 5/048

(57) ABSTRACT

The present disclosure relates to systems and methods for probabilistically estimating an individual's pulse rate in the presence of nontrivial noise spectra. In one implementation, the method may include receiving a set of signals from a set of sensors associated with the device, the set of signals including a photoplethysmographic (PPG) signal obtained from the individual; transforming the PPG signal to the frequency domain; applying a band-pass filter to the transformed signal to generate a filtered signal; identifying one or more peaks in the filtered signal; generating a set of one or more sample classifiers for each peak in the set of one or more peaks; and comparing the set of sample classifiers to a set of library classifiers included in a learning library. Each library classifier is associated with a classification coefficient reflecting a degree of correlation between the library classifier and a known pulse rate profile.

### CROSS-REFERENCE TO RELATED APPLICATION(S)

This application claims the benefit of priority of U.S. Provisional Application No. 62/289,781, filed Feb. 1, 2016, which is incorporated herein by reference in its entirety.

### TECHNICAL FIELD

The present disclosure generally relates to systems and methods for measuring physiological parameters of an individual. More particularly, and without limitation, the disclosed embodiments relate to systems and methods for estimating a pulse rate in the presence of signal spectra including nonstationary (i.e., including time-dependent frequencies) and nontrivial (i.e., with non-zero eigenvalues) noise.

### BACKGROUND

Determining an individual's pulse rate(s) can provide useful health information, such as an individual's resting pulse rate or pulse rate during certain forms of exercise. One method of measuring a pulse rate includes a photoplethysmogram (PPG). A PPG is an optically obtained plethysmogram, which refers generally to a volumetric measurement of an organ. A PPG utilizes volumetric measurement of skin and is often obtained using a pulse oximeter, which illuminates the skin and measures changes in light absorption, thereby measuring volumetric changes of the skin. Many individuals may wish to determine their pulse rate(s) during times of intense activity (e.g., exercise) or during times of nontrivial erratic (i.e., irregular) movements (e.g., bus rides, walking, etc.). Conventional methods for determining a pulse rate, however, can fail to provide accurate results in the presence of nontrival noise spectra. Other factors can also impair pulse rate estimation using traditional measurement systems and techniques.

### SUMMARY

The disclosed embodiments may include computer-implemented systems and methods for probabilistically estimating an individual's pulse rate, e.g., in the presence of nontrivial signal and noise spectra. The disclosed embodiments may provide systems and methods for determining pulse rate likelihoods (i.e., the probability that a given pulse rate of an identified peak in the signal corresponds to an individual's true pulse rate) in a filtered photoplethysmographic (PPG) signal. An estimation of the true pulse rate may be made based on the degree of correlation between classifiers derived from the signal and classifiers included in a learning library containing other true pulse rates.

The disclosed embodiments may include, for example, systems and methods that generate a set of sample classifiers for each identified peak, wherein the set of sample classifiers includes a harmonic classifier and an activity classifier. A sample classifier may be any function of the received set of signals. The function may include, for example, a sum of weighted signals, a product of weighted signals, a multivariate polynomial function where each signal has a corresponding signal weight and power, a statistical analysis of the set of signals like a multivariable regression analysis, or any combination thereof. The operations may also include comparing the set of sample classifiers to a set of library classifiers included in a learning library, wherein each library classifier is associated with a classification coefficient reflecting a degree of correlation between the library classifier and a known pulse rate.

The disclosed embodiments may include, for example, a method for probabilistically estimating an individual's pulse rate using a device worn on the individual. The method may comprise one or more operations performed via at least one or more processors of the device. The operations may include receiving a set of signals from a set of sensors (including, for example, an optical pulse rate monitor or an optical blood pressure sensor) associated with the device. The device may be a wearable/body-mountable device, and the set of signals may include a PPG signal obtained from the individual. The operations may also include transforming the PPG signal to the frequency domain (e.g., via a Laplace or Fourier transform) and applying a band-pass filter to the transformed signal to generate a filtered signal. The band-pass filter may reduce or remove both high frequency and low frequency noise in the PPG signal. The operations may also include identifying a set of one or more peaks in the filtered signal. A peak reflects a local maximum whose amplitude exceeds a threshold, which may be preset or may be dynamically determined. The operations may also include generating a set of one or more sample classifiers for each peak in the set of one or more peaks. The set of sample classifiers may include both a harmonic classifier and an activity classifier. The operations may also include comparing the set of one or more sample classifiers to a set of library classifiers included in a learning library. Each library classifier may be associated with a classification coefficient reflecting a degree of correlation between the library classifier and a known pulse rate. The operations may also include determining a pulse rate likelihood for each peak in the set of one or more peaks based on the set of sample classifiers, the set of classification coefficients, and a pulse rate corresponding to the peak.

The disclosed embodiments may also include, for example, a system for probabilistically estimating an individual's pulse rate using a device worn on the individual. The system may comprise a memory storing instructions and one or more processors configured to execute the instructions to perform one or more operations. The operations may include receiving a set of signals from a set of sensors associated with the device. The device may be a wearable/body-mountable device, and the set of signals may include a PPG signal obtained from the individual. The operations may also include transforming the PPG signal to the frequency domain and applying a band-pass filter to the transformed signal to generate a filtered signal. The operations may also include identifying a set of one or more peaks in the filtered signal. A peak reflects a local maximum whose amplitude exceeds a threshold, which may be preset or may be dynamically determined. The operations may also include generating a set of one or more sample classifiers for each peak in the set of one or more peaks. The set of sample classifiers may include both a harmonic classifier and an activity classifier. The operations may also include comparing the set of one or more sample classifiers to a set of library classifiers included in a learning library. Each library classifier may be associated with a classification coefficient reflecting a degree of correlation between the library classifier and a known pulse rate. The operations may also include determining a pulse rate likelihood for each peak in the set of one or more peaks based on the set of sample classifiers, the set of classification coefficients, and a pulse rate corresponding to the peak.

The disclosed embodiments may also include, for example, a tangible, non-transitory computer-readable medium storing instructions, that, when executed by at least one processor, cause the at least one processor to perform a method for probabilistically estimating a user's pulse rate in the presence of nontrivial noise spectra using a device worn on the user. The method may comprise one or more operations. The operations may include receiving a set of signals from a set of sensors associated with the device. The device may be a wearable/body-mountable device, and the set of signals may include a PPG signal obtained from the individual. The operations may also include transforming the PPG signal to the frequency domain and applying a band-pass filter to the transformed signal to generate a filtered signal. The operations may also include identifying a set of one or more peaks in the filtered signal. A peak reflects a local maximum whose amplitude exceeds a threshold, which may be preset or may be dynamically determined. The operations may also include generating a set of one or more sample classifiers for each peak in the set of one or more peaks. The set of sample classifiers may include both a harmonic classifier and an activity classifier. The operations may also include comparing the set of one or more sample classifiers to a set of library classifiers included in a learning library. Each library classifier may be associated with a classification coefficient reflecting a degree of correlation between the library classifier and a known pulse rate. The operations may also include determining a pulse rate likelihood for each peak in the set of one or more peaks based on the set of sample classifiers, the set of classification coefficients, and a pulse rate corresponding to the peak.

Additional features and advantages of the disclosed embodiments will be set forth in part in the description that follows, and in part will be obvious from the description, or may be learned by practice of the disclosed embodiments. The features and advantages of the disclosed embodiments will be realized and attained by the elements and combinations particularly pointed out in the appended claims.

It is to be understood that both the foregoing general description and the following detailed description are examples and explanatory only and are not restrictive of the disclosed embodiments as claimed.

The accompanying drawings constitute a part of this specification. The drawings illustrate several embodiments of the present disclosure and, together with the description, may serve to explain the principles of the disclosed embodiments as set forth in the accompanying claims.

### BRIEF DESCRIPTION OF THE DRAWINGS

FIG. 1 depicts an example system environment for implementing embodiments consistent with the present disclosure.

FIG. 2 depicts an example computing system consistent with the disclosed embodiments.

FIG. 3 depicts a flowchart for an example process for probabilistically estimating pulse rates consistent with the disclosed embodiments.

FIG. 4 depicts a flowchart for an example process for identifying peaks in a transformed photoplethysmographic signal consistent with the disclosed embodiments.

FIG. 5 depicts a flowchart for an example process for constructing a learning library consistent with the disclosed embodiments.

FIG. 6 depicts a flowchart for an example process for determining a set of pulse rate likelihoods consistent with the disclosed embodiments.

FIG. 7 depicts a flowchart for an example process for determining harmonic classifiers consistent with the disclosed embodiments.

FIG. 8 depicts a flowchart for an example process for incorporating external inputs consistent with the disclosed embodiments.

FIG. 9 depicts a flowchart for an example process for incorporating user libraries and classifiers consistent with the disclosed embodiments.

### DETAILED DESCRIPTION

The disclosed embodiments relate to systems and methods for probabilistically estimating an individual's pulse rate from photoplethysmographic (PPG) signals in the presence of dynamically evolving, nontrivial noise spectra. In some aspects, the disclosed embodiments may obtain one or more signals, such as a PPG signal, from sensor(s) associated with a device worn on the individual. The disclosed embodiments may analyze each signal, for example, to determine peaks in the PPG signal transformed in the frequency domain. The disclosed embodiments may further analyze other signals such as accelerometer signals, GPS signals, gyroscope signals, and so on to provide further context to the PPS signal. The disclosed embodiments may then generate a set of sample classifiers based on the analyzed signals, such as a harmonic classifier, an activity classifier, a location classifier, a waveform classifier, and so forth. These classifiers may be generated on a per-signal and/or per-peak basis. In some aspects, the disclosed embodiments may compare the measured set of signals and/or the derived set of sample classifiers to corresponding sets of library signals and/or library classifiers in a learning library training set. In certain aspects, the learning library training set may include classification coefficients reflecting a degree of correlation between known pulse rates and the set of library classifiers.

Providing probabilistic estimates consistent with the disclosed embodiments may provide one or more technical advantages and improvements. For example, the disclosed embodiments may provide more accurate measurements of an individual's pulse rate in a noisy environment, such as during exercise, riding in vehicles producing their own noise spectra, during constantly evolving conditions, etc. This advantage may be particularly pertinent because these environments may correlate with the circumstances during which an individual is more likely to measure his or her pulse rate (e.g., during exercise). Furthermore, the disclosed embodiments may additionally improve the accuracy of such pulse rate measurements by incorporating information unique to users, accounting for user or external inputs, incorporating information from several signal types, and the like.

Reference will now be made in detail to embodiments of the present disclosure, examples of which are illustrated in the accompanying drawings. Where possible, the same reference numbers will be used throughout the drawings to refer to the same or like parts.

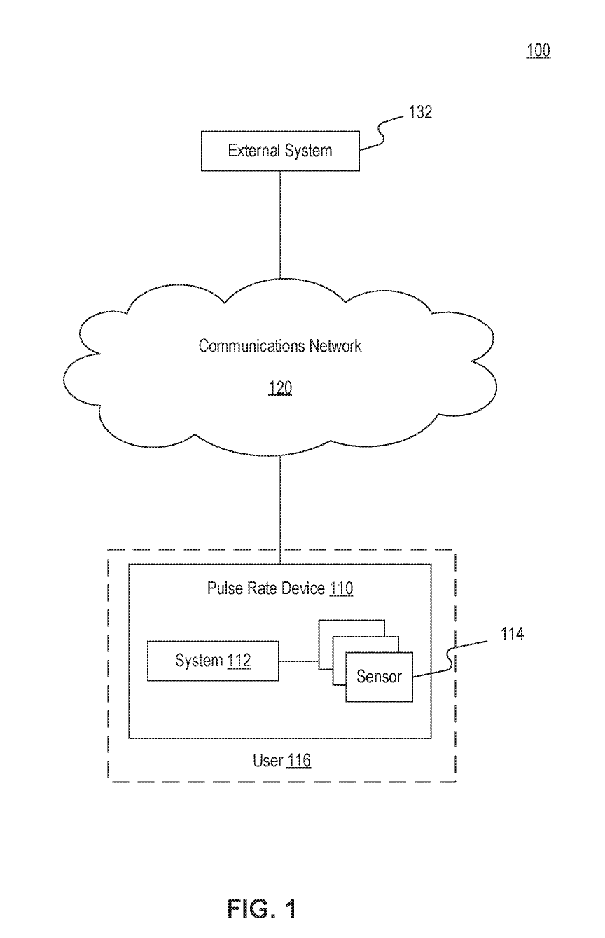

FIG. 1 depicts an example system environment 100 for implementing embodiments consistent with the present disclosure. In some aspects, environment 100 may include one or more pulse rate devices (e.g., pulse rate device 110), which may be associated with one or more users (e.g., user 116). In some aspects, pulse rate device 110 may include one or more systems 112 for implementing processes consistent with the disclosed embodiments. The one or more device systems 112 may be communicatively connected to a set of one or more sensors 114. Sensors 114 may be included within pulse rate device 110 (as depicted in FIG. 1) or may be external to the pulse rate device. Environment 100 may include one or more external computing systems (e.g., external system 132). One or more communications networks (e.g., communications network 120) may communicatively connect one or more of the components of environment 100.

Pulse rate device 110 may comprise any computing or data processing device consistent with the disclosed embodiments. In some aspects, for example, pulse rate device 110 may comprise a wearable device implemented with hardware devices and/or software applications running thereon for implementing the disclosed embodiments. In certain embodiments, pulse rate device 110 may incorporate the functionalities associated with a personal computer, a laptop computer, a tablet computer, a notebook computer, a hand-held computer, a personal digital assistant, a portable navigation device, a mobile phone, an embedded device, a smartphone, and/or any additional or alternate computing device. Pulse rate device 110 may transmit and receive data across a communications network (e.g., network 120). Pulse rate device 110 may further implement aspects of the disclosed embodiments without accessing other devices or networks, such as network 120 or external device 132.

In certain aspects, pulse rate device 110 may be associated with one or more users, such as user 116. In one example, user 116 may wear pulse rate device 110 (e.g., around the user's wrist, leg, chest, etc.) to perform one or more processes consistent with the disclosed embodiments, such as that described with reference to FIGS. 1-9. For example, user 116 may use pulse rate device 110 to input information, receive information, display information, and transmit information to and from other components in system environment 100, such as an external system 132. This information may comprise any data consistent with the disclosed embodiments.

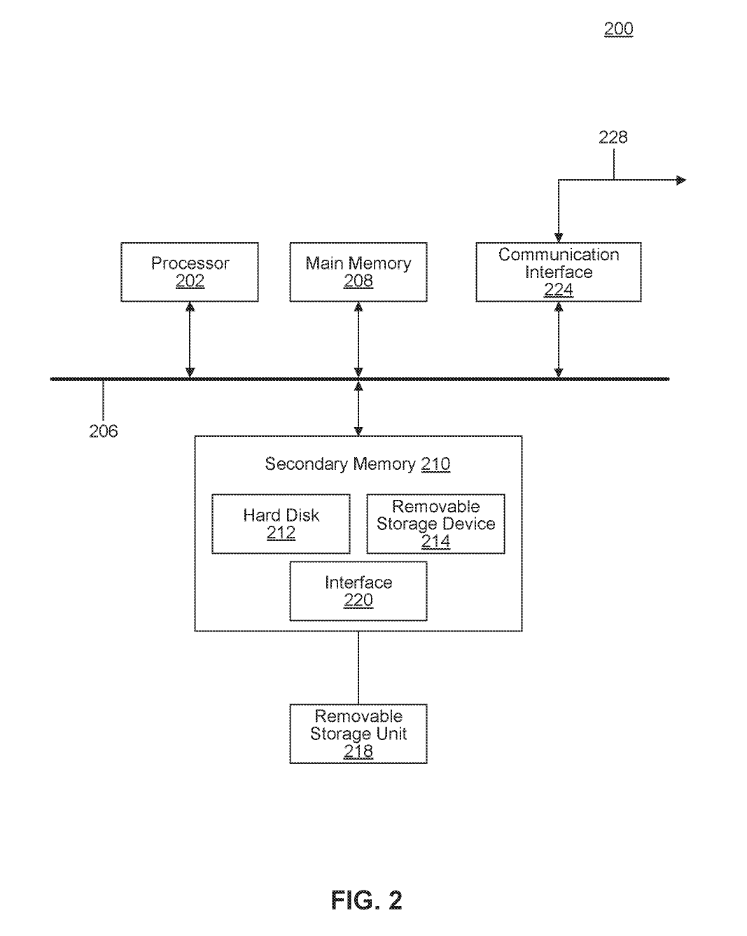

Pulse rate device 110 may include one or more computing systems 112 for processing, storing, receiving, obtaining, and/or transmitting information, such as computing system 200 described in connection with FIG. 2. In some aspects, system 112 may be implemented with hardware devices and/or software instructions to perform one or more operations consistent with the disclosed embodiments (see, e.g., the example embodiments described with reference to FIGS. 1-9). The software instructions may be incorporated into a single computer or any additional or alternative computing device apparent to one of ordinary skill in the art (e.g., a single server, multiple devices, etc.). System 112 may also include or associate with distributed computing devices and computing systems, and may execute software instructions on separate computing systems by remotely communicating over a network (e.g., communications network 120). System 112 may also implement aspects of the disclosed embodiments without accessing other devices or networks, such as network 120. Pulse rate device 110 and/or system 112 may also be implemented with one or more data storages for storing information consistent with the embodiments described below.

In some aspects, pulse rate device 110 may communicate with a set of sensors 114. Sensors 114 may measure any physical, temporal, geospatial, and/or environmental characteristic associated with user 116. For example, sensors 114 may include an optical pulse rate monitor, optical blood pressure sensor, a GNSS receiver/transceiver, GPS receiver, accelerometer, gyroscope, thermometer, compass, posture sensor, hygrometer, pressure sensor, electrocardiogram, clock, and/or other such sensor. Sensors 114 may measure characteristics internal to user 116 (e.g., the user's pulse rate, body temperature, blood pressure, etc.), external to user 116 (e.g., the ambient temperature, humidity, moisture levels, air pressure, barometric pressure, etc.), or otherwise associated with user 116 (e.g., the user's location, speed, direction of travel, altitude, lateral or longitudinal acceleration, etc.). The set of sensors 114 may be implemented as hardware components within pulse rate device 110, reside external to the device, or some combination of the two. Preferably, pulse rate device 110 includes each sensor in the set of sensors 114.

In some aspects, pulse rate device 110 may use signals received from sensors 114 to determine or derive information associated with user 116. For instance, pulse rate device 110 may receive, measure, or detect a PPG signal associated with user 116 (e.g., via an optical pulse rate sensor). Pulse rate device 110 may determine a user's location based on GNSS/GPS measurements. Pulse rate device 110 may determine the speed and/or direction user 116 is moving based on changes in the user's location over a given time (e.g., from a GNSS sensor and a clock), longitudinal acceleration (e.g., from an accelerometer), and/or compass readings, etc. Pulse rate device 110 may determine a user's activity based on, for example, a determined speed associated with the user, the user's location, the user's posture, etc. Pulse rate device 110 may determine a posture associated with user 116 based on, for example, gyroscope measurements or a posture sensor. Pulse rate device 110 may derive, detect, or determine any such information from sensors 114 consistent with the disclosed embodiments. As used below, any sensor signal or other physical, temporal, or environmental characteristic derived therefrom (e.g., speed, acceleration, harmonics in a PPG signal, user activity, etc.) may be referred to as a “signal,” although such description is used for illustrative purposes only and is not intended to be limiting.

Environment 100 may include one or more communications networks 120. In some aspects, network 120 may represent any type of communications network or medium of digital communication for transmitting information between computing devices. For example, network 120 may include a LAN, a wireless LAN, a cellular network, an RF network, a Near Field Communication (NFC) network (e.g., a WiFi network), a wireless Metropolitan Area Network (MAN) connecting multiple wireless LANs, NFC communication link(s), any physical wired connection (e.g., via an I/O port), and/or a WAN (e.g., the Internet). In some embodiments, network 120 may be secured through physical encryption (e.g., line encryption), by requiring information to be encrypted on other computer systems (e.g., end encryption), and the like.

In certain aspects, network 120 may include any accessible network or networks interconnected via one or more communications protocols, including hypertext transfer protocol (HTTP) and transmission control protocol/internet protocol (TCP/IP). Communications protocols consistent with the disclosed embodiments may also include protocols facilitating data transfer using radio frequency identification (RFID) communications and/or NFC. In some aspects, network 120 may also include one or more mobile device networks, such as a GSM network or a PCS network, allowing devices (e.g., pulse rate device 110) to send and receive data via applicable communications protocols, including those described herein.

Environment 100 may include one or more external systems (e.g., external system 132) for processing, storing, receiving, obtaining, and transmitting information. External system 132 may comprise any type of computing system consistent with the disclosed embodiments, such as computing system 200 of FIG. 2. External system 132 may be implemented with hardware devices and/or software instructions to perform one or more operations consistent with the disclosed embodiments, such as those described with reference to FIGS. 2-9. The software instructions may be incorporated in a single system or may be distributed among several systems. In certain aspects, external system 132 may include one or more servers and/or one or more data repositories, memories, or other storages for storing and managing information. External system 132 may communicate information with one or more other components of environment 100 (e.g., pulse rate device 110, another external system 132, etc.) via one or more communications network 120.

In some aspects, external system 132 may reflect a computing system directly associated with, storing data for, hosting, or otherwise communicating with pulse rate device 110. Additionally or alternatively, external system 132 may reflect a computing system of an external entity not directly associated with pulse rate device 110, such as a computing system associated with a third-party business, governmental organization, educational institution, etc.

FIG. 2 depicts a block diagram of an example computer system 200 consistent with the disclosed embodiments. For example, in some aspects, computer system 200 may comprise computer systems associated with a device (e.g., pulse rate device 110, external system 132, etc.) performing one or more of the processes disclosed herein. In some embodiments, computer system 200 may include one or more processors 202 connected to a communications backbone 206 such as a bus or external communications network (e.g., any medium of digital data communication such as a LAN, MAN, WAN, cellular network, WiFi network, NFC link, Bluetooth, GSM network, PCS network, I/O connection, any wired connection such as USB or hardwired circuitry, and any associated protocols such as HTTP, TCP/IP, RFID, etc). Communications backbone 206 and/or one or more other components of computing system 200 may directly or indirectly communicatively connect the system to other components or peripherals, such as a set of sensors 114 (e.g., as implemented within pulse rate device 110).

In certain aspects, computer system 200 may include main memory 208. Main memory 208 may comprise random access memory (RAM) representing a tangible and nontransitory computer-readable medium storing computer programs, sets of instructions, code, or data executed with processor 202. When executed by processor 202, such instructions, computer programs, etc., may enable processor 202 to perform one or more processes or functions consistent with the disclosed embodiments. In some aspects, such instructions may include machine code (e.g., from a compiler) and/or files containing code that processor 202 may execute with an interpreter.

In some aspects, main memory 208 may also include or connect to a secondary memory 210. Secondary memory 210 may include a disk drive 212 (e.g., HDD, SSD), and/or a removable storage drive 214, such as a magnetic tape drive, flash memory, an optical disk drive, CD/DVD drive, or the like. The removable storage drive 214 may read from and/or write to a removable storage unit 218 in a manner known to the skilled artisan. Removable storage unit 218 may represent a magnetic tape, optical disk, or other storage medium that is read by and written to by removable storage drive 214. Removable storage unit 218 may represent a tangible and non-transitory computer-readable medium having stored therein computer programs, sets of instructions, code, or data to be executed by processor 202.

In other embodiments, secondary memory 210 may include other means for allowing computer programs or other program instructions to be loaded into computer system 200. Such means may include, for example, another removable storage unit 218 or an interface 220. An example of such means may include a removable memory chip (e.g., EPROM, RAM, ROM, DRAM, EEPROM, flash memory devices, or other volatile or nonvolatile memory devices) and associated socket, or other removable storage units 218 and interfaces 220, which may allow instructions and data to be transferred from the removable storage unit 218 to computer system 200.

Computer system 200 may also include one or more communications interfaces 224. Communications interface 224 may allow software and data to be transferred between computer system 200 and external systems (e.g., in addition to backbone 206). Communications interface 224 may include a modem, a network interface (e.g., an Ethernet card), a communications port, a PCMCIA slot and card, etc. Communications interface 224 may transfer software and data in the form of signals, which may be electronic, electromagnetic, optical or other signals capable of being received by communications interface 224. These signals may be provided to communications interface 224 via a communications path (e.g., channel 228). Channel 228 may carry signals and may be implemented using wire, cable, fiber optics, RF link, and/or other communications channels. In one embodiment, the signals may comprise data packets sent to or coming from processor 202. For example, computer system 200 may receive signals from a set of sensors (e.g., sensors 114) via communications interface 224 and/or communications backbone 206. Information representing processed packets may also be sent in the form of signals from processor 202 through communications path 228.

In certain aspects, the computer-implemented methods described herein may be implemented on a single processor of a computer system, such as processor 202 of computer system 200. In other embodiments, these computer-implemented methods may be implemented using one or more processors within a single computer system and/or on one or more processors within separate computer systems in communication over a network.

In certain embodiments, the terms “storage device” and “storage medium” may refer to particular devices including, but not limited to, main memory 208, secondary memory 210, a hard disk installed in hard disk drive 212, and removable storage unit 218 of FIG. 2. Further, the term “computer-readable medium” may refer to devices including, but not limited to, a hard disk installed in hard disk drive 212, any combination of main memory 208 and secondary memory 210, and removable storage unit 218, which may respectively provide computer programs and/or sets of instructions to processor 202 of computer system 200. Such computer programs and sets of instructions can be stored within one or more computer-readable media. In certain aspects, computer programs and sets of instructions may also be received via communications interface 224 and stored on the one or more computer-readable media.

The disclosed embodiments may include systems and methods for probabilistically estimating an individual's pulse rate in the presence of nonstationary and nontrivial signal and noise spectra. The disclosed embodiments may measure a set of signals including a PPG signal from a set of sensors 114, transform at least the PPG signal into the frequency domain, and apply a band-pass filter to the transformed signal. The disclosed embodiments may identify peaks in the filtered signal whose amplitude exceeds a threshold. For each identified peak, the disclosed embodiments may generate a set of sample classifiers, such as a harmonic classifier and/or an activity classifier. The disclosed embodiments may then compare the generated sample classifier(s) to a set of library classifier(s) associated with a learning library (e.g., a training set), such that each library classifier is associated with a classification coefficient reflecting a degree of correlation between the library classifier and a previously measured, known pulse rate or pulse rate profile (e.g., a distribution of a PPG signal in the time or frequency domain). The disclosed embodiments may then determine a pulse rate likelihood for each identified peak based on the set of sample classifiers, the set of classification coefficients, and the pulse rate associated with the identified peak.

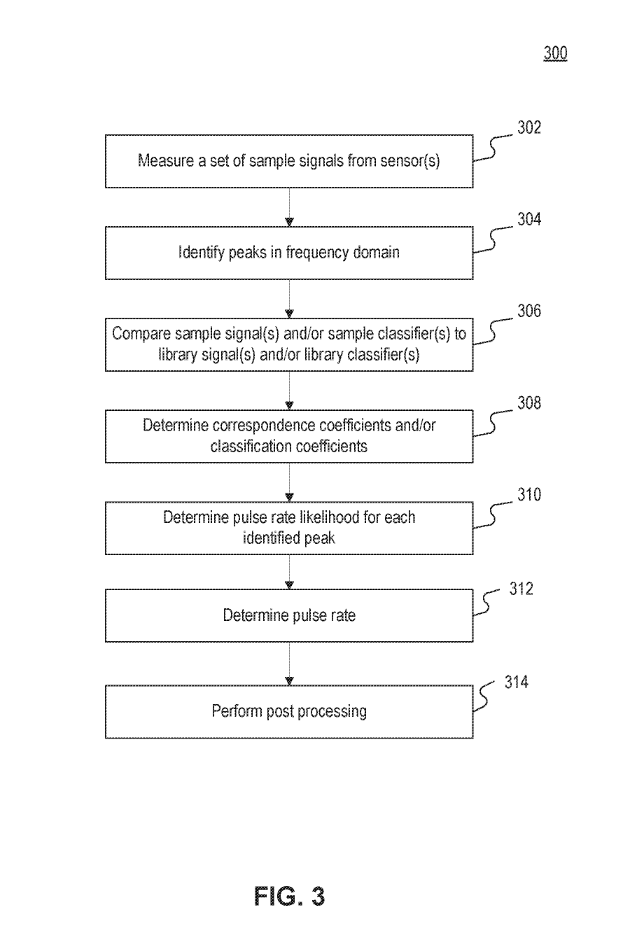

FIG. 3 depicts a flowchart for an example process 300 for probabilistically estimating pulse rates consistent with the disclosed embodiments. The example process 300 may be implemented via hardware and/or software instructions on one or more of the components of environment 100 such as pulse rate device 110, external system 132, or any combination thereof. Moreover, in certain aspects, process 300 may occur or be implemented as a standalone process. In other embodiments, process 300 may take place in the context of other processes. Certain aspects of process 300 may be reordered, rearranged, repeated, omitted, supplemented, modified, or integrated into additional processes in ways consistent with the disclosed embodiments.

In the example process 300 of FIG. 3, the process begins by detecting, measuring, and/or otherwise receiving a set of sample signals S_{S} from a set of sensors 114 (step 302). The set of sample signals S_{S} may include one or more signals, such as a PPG signal measured with an optical heart rate sensor included on pulse rate device 110. In some aspects, the set of sample signals S_{S} may include other signals consistent with the disclosed embodiments. For example, the set of sample signals S_{S} may include a posture signal, a location signal, a speed signal, a temperature signal, etc., received from or derived from the set of sensors 114 implemented within or associated with pulse rate device 110. Similarly, the set of sensors 114 may include one or more sensors, such as an optical pulse rate sensor. In some aspects, the set of sensors 114 may include other sensors such as a GNSS sensor, a GPS receiver, a thermometer, an air pressure sensor, or any other sensor consistent with the disclosed embodiments (e.g., the types of sensors described with connection with FIG. 1).

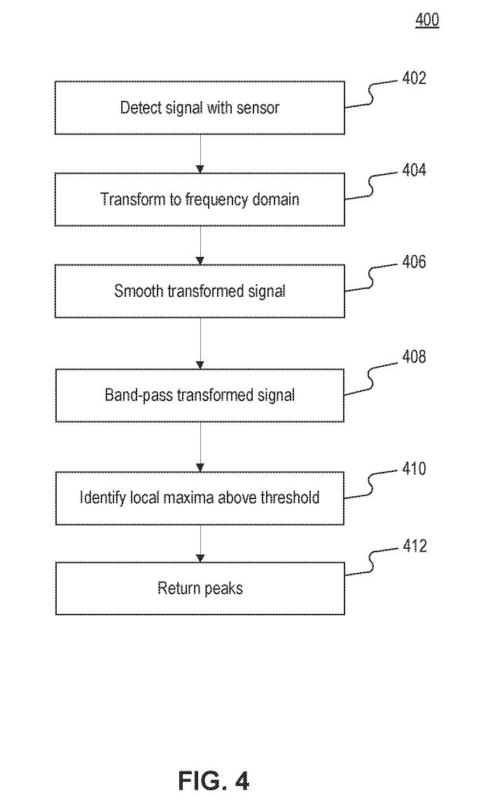

Process 300 may include transforming a sampled PPG signal, filtering the transformed signal, and identifying a set of peaks, Π, of the filtered signal in the frequency domain (step 304). In some aspects, a peak πᵢ may reflect a local maximum of the transformed PPG signal amplitude in frequency space. Process 300 may identify the set of peaks Π using processes consistent with the disclosed embodiments, such as those described with reference to FIG. 4. In some embodiments, for instance, process 300 may transform a measured PPG signal into the frequency domain by applying a fast Fourier transform (FFT) or other suitable transform to the PPG signal. The disclosed embodiments may then band-pass the transformed signal and identify a set of local maxima in the resulting signal. In this example, each peak of the filtered signal occurs at a frequency corresponding to a potential pulse rate of the user. The disclosed embodiments may use these peaks and information contained in the signals to estimate the likelihood that each peak corresponds to the user's pulse rate.

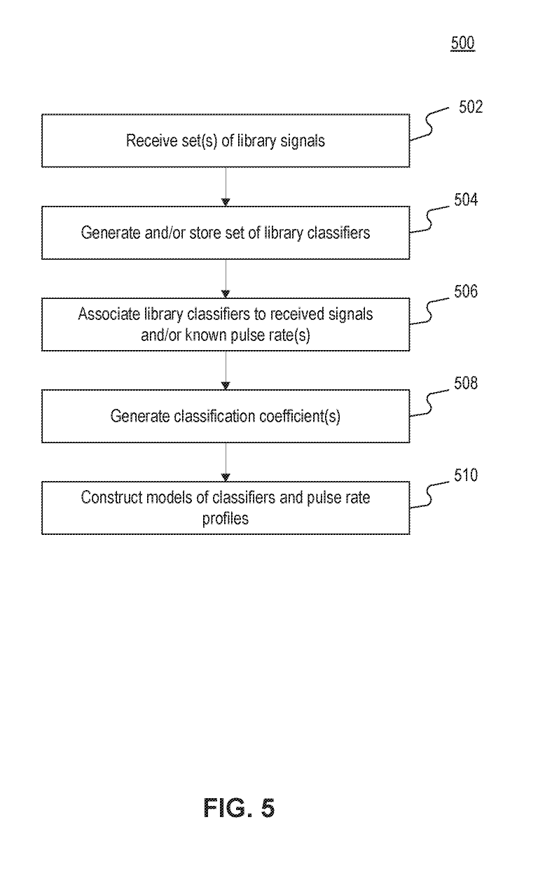

In some embodiments, process 300 may include comparing the set of sample signals S_{S} measured from the set of sensors 114, including any transformed or derived signals (e.g., a speed signal), to a set of library signals S_{L} associated with a learning library stored in memory (step 306). In some embodiments, the learning library may comprise a training set of data wherein sets of library signals, which may include derived or transformed signals, are associated with known, preferably accurate, previously-determined pulse rates or pulse rate profiles (e.g., a PPG signal distribution or waveform, etc.). In these aspects, the set of library signals S_{L} may reflect the set of signals received, derived, or transformed during the training of the learning library. These library signals may include, for instance, PPG signals, speed signals, posture signals, location signals, or any other type of suitable signal consistent with the disclosed embodiments. The learning library and other derived parameters may be established using processes consistent with the disclosed embodiments, such as those described with reference to FIG. 5.

Additionally or alternatively, process 300 may include generating a set of sample classifiers C_{S} based on the set of sample signals S_{S}. In certain aspects, sample classifier c_{S} may reflect a feature of the set of sample signals S_{S} having a known correlation with a pulse rate or pulse rate profile. As described in further detail below, process 300 may compare the set of sample classifiers C_{S} to a set of library classifiers C_{L} associated with the learning library. The set of library classifiers C_{L} may reflect features of the library signals S_{L} having determined correlations with known, previously-determined pulse rates or pulse rate profiles. Process 300 may determine a correlation between a sample classifier c_{S} and a potential pulse rate based in part on the library classifiers in the learning library. Process 300 may generate sets of sample and/or library classifiers using processes consistent with the disclosed embodiments, such as those described in connection with FIGS. 5-7. As described herein, the term “classifier” may refer to the type of classifier used (e.g., a posture classifier) and/or its value (e.g., prone, erect, sitting, etc.), based on the context.

In certain aspects, process 300 may determine a classification coefficient, γ, and/or a correspondence coefficient, σ, for each sample classifier c_{S} in the set of sample classifiers C_{S} (step 308). Classification coefficient γ may reflect a degree of correlation, confidence, significance, and/or prediction between a library classifier c_{L} and a known, previously-determined pulse rate in the learning library. This correlation may represent a relationship, interdependence, or significance a library classifier c_{L} or its value has with the known pulse rate. For example, training data in the learning library may indicate that certain classifiers and/or their values are better predictors of (e.g., are more highly correlative with) known pulse rates in the learning library. These classifiers may be associated with higher classification coefficients than those that are weaker (e.g., less correlative) predictors of a user's pulse rate. In some aspects, the disclosed embodiments may impute a classification coefficient γ of a library classifier c_{L} to a sample classifier c_{S} based on each classifier's value and/or the values of other classifiers and signals. The disclosed embodiments may generate or store classification coefficients locally (e.g., on pulse rate device 110), externally, (e.g., on external system 132), or some combination thereof. For example, classification coefficients may be stored locally but may be continually or periodically updated based on information received from an external system 132. The set of classification coefficients Γ and the set of correspondence coefficients Σ for each peak πᵢ may be determined using processes consistent with the disclosed embodiments.

Process 300 may also include determining a correspondence coefficient σ for each classifier in the set of sample classifiers C_{S}. Correspondence coefficient σ may reflect a degree of correlation between a sample classifier c_{S} and a library classifier c_{L} defined in a learning library. In some aspects, this correlation may reflect a degree of similarity between the one or more signal profiles (e.g., values, distributions, etc.) generating the sample classifier and those used to create and/or define the corresponding library classifier c_{L}. In one example, a learning library may define a certain logical or mathematical combination of signals to generate a posture classifier (e.g., based on a combination of signals received or derived from a posture sensor, a gyroscope, an accelerometer, etc.). The posture classifier may take one of several values based on the received signals, such as reclined, lying down, standing, sitting, etc. In this example, the correspondence coefficient may reflect the correlation between the received sample signals from the set of sensors 114 used to generate the sample classifier and the library classifier defined in the learning library (e.g., the likelihood that the user is in fact reclining, lying down, etc.). The disclosed embodiments may determine correspondence coefficients for other classifiers consistent with the disclosed embodiments (e.g., activity classifiers, harmonic classifiers, waveform classifiers etc.) in a similar manner based on the correlation of the input signals.

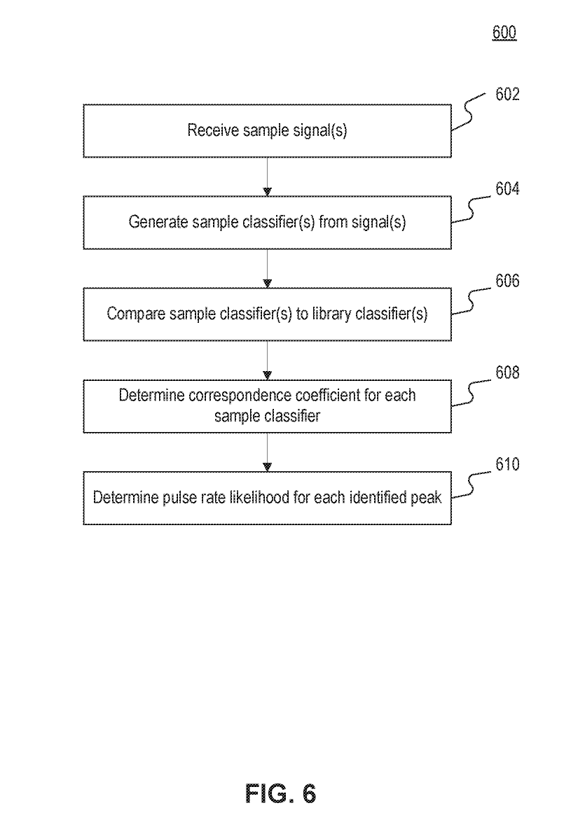

In some aspects, process 300 may include determining a pulse rate likelihood for each identified peak in the filtered PPG signal (step 310). The pulse rate likelihood p(πᵢ) may reflect the likelihood that a pulse rate vᵢ of an identified peak πᵢ corresponds to an individual's true pulse rate. Process 300 may determine the set of pulse rate likelihoods P as a function of the pulse rate vᵢ associated with each peak π₁, the set of classification coefficients Γᵢ associated with the peak, and the set of correspondence coefficients Σᵢ associated with the peak, p(πᵢ)=f(vᵢ,Γᵢ,Σᵢ), consistent with the disclosed embodiments (e.g., as described with reference to FIG. 6).

Process 300 may include determining an individual's pulse rate from the set of pulse rate likelihoods, P (step 312). Process 300 may determine this pulse rate in any manner consistent with the disclosed embodiments. In one aspect, for example, process 300 may estimate the individual's pulse rate to be equal to the rate corresponding to the most likely peak, \hat{p}=max{p(πᵢ)}ᵢ, where p(πᵢ) is an element of the set of pulse rate likelihoods P. In another example, process 300 may ensure that the most likely peak has a pulse rate likelihood exceeding a pulse likelihood threshold max{p(πᵢ)}ᵢ>Tₚₗ. This threshold may, for example, be 80% or higher, 60% or higher, 50% or higher, etc. In yet another example, process 300 may determine the pulse rate as a function of all of the peaks with pulse rate likelihoods exceeding a second pulse likelihood threshold (which may be equal to or different than a first pulse likelihood threshold described previously), \hat{p}=f(p(πᵢ)>T′ₚₗ). Process 300 may further base the pulse rate on previously determined pulse rates or pulse rate likelihoods. For example, when no pulse rate likelihood exceeds a pulse likelihood threshold, process 300 may assume the current pulse rate is the same as a previously determined sleep stage, and/or weigh the current set of pulse rate likelihoods by those previously generated (e.g., by averaging them, computing a moving average of the last few such computations, etc.), and/or determine whether the weighed pulse rate likelihoods exceed the pulse likelihood threshold or doing so without subjecting the weighed likelihoods to the threshold, etc.

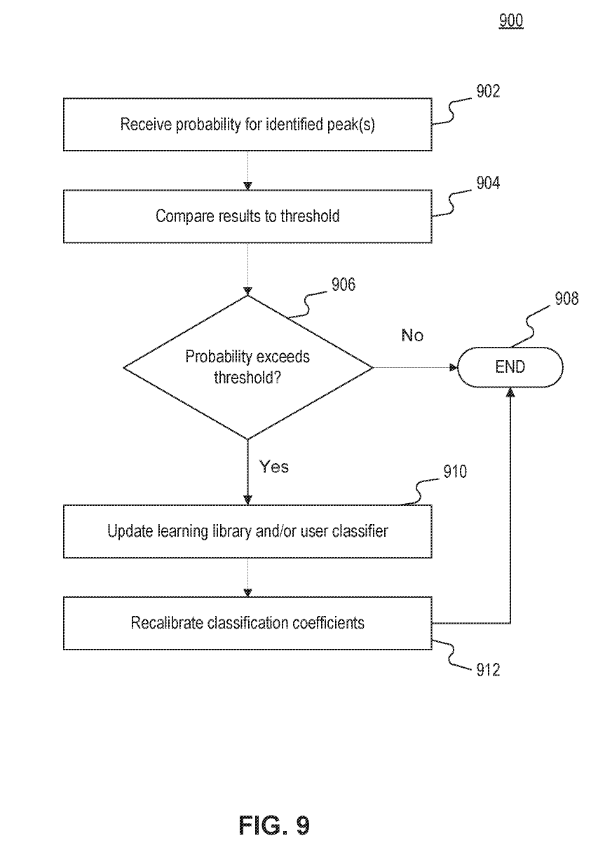

In some embodiments, process 300 may include conducting post processing consistent with the disclosed embodiments (step 314). In certain aspects, such post processing may include updating the learning library and/or library classifiers C_{L} and classification coefficients γ, such as using processes described in connection with FIG. 9. Alternatively or additionally, post processing may include storing data in a computing system (e.g., within pulse rate device 110, information transmitted to external system 132, etc.). This stored data may include information associated with the measured set of signals, generated classifiers, set of pulse rate likelihoods, estimated pulse rates, or any other information consistent with the disclosed embodiments. Post processing may also include displaying an estimated pulse rate on a display of pulse rate device 110. In some aspects, displaying the estimated pulse rate may occur responsive to a user's input provided to the device.

FIG. 4 depicts a flowchart for an example process 400 for identifying peaks in a transformed photoplethysmographic (PPG) signal consistent with the disclosed embodiments. The example process 400 may be implemented via hardware and/or software instructions on one or more of the components of environment 100 such as pulse rate device 110, external system 132, or any combination thereof. Moreover, in certain aspects, process 300 may occur or be implemented as a standalone process. In other embodiments, process 300 may take place in the context of other processes (e.g., the probabilistic pulse rate estimation process 300 described in connection with FIG. 3). Certain aspects of process 400 may be reordered, rearranged, repeated, omitted, supplemented, modified, or integrated into additional processes in ways consistent with the disclosed embodiments.

In the example process 400 of FIG. 4, the process begins by detecting, measuring, and/or otherwise receiving a PPG signal from a sensor 114 (step 402). This sensor may include, for instance, an optical pulse rate sensor installed within pulse rate device 110. The PPG signal may take any suitable form known to one of ordinary skill in the art. In some aspects, the PPG signal may reflect a measure of light transmitted and/or reflected, e.g., by tissue of an individual, over time, e.g., as measured by a photodiode of sensor 114 (e.g., an optical pulse rate sensor). This measure may correspond to a volumetric measurement of blood in certain tissues and/or one or more organs of an individual.

Process 400 may include transforming the measured PPG signal to the frequency domain to generate a transformed signal (step 404). In some aspects, this transformation may comprise applying any suitable transformation to the measured PPG signal known to one of ordinary skill in the art. In one example, for instance, process 400 may apply an FFT to the PPG signal to transform it into the frequency domain. Such transformations may also include other numerical, discrete transformations such as a Discrete Fourier Transform (DFT), or other types of FFTs such as the Cooley-Tukey algorithm, the prime-factor algorithm, Bruun's algorithm, Rader's algorithm, and the like. Transforming the PPG signal may generate a transformed signal in frequency space such that the signal reflects a distribution of signal amplitude over a range of frequencies.

In some embodiments, process 400 may including smoothing either the measured PPG signal or the transformed signal (step 406). The smoothing subroutine of process 400 may include any suitable smoothing algorithm or filter consistent with the disclosed embodiments, such as rectangular smoothing, triangular smoothing, Savitzky-Golay smoothing, Laplacian smoothing, additive smoothing, haystack smoothing, a Butterworth filter, a Kolmogorov-Zurkenko filter, a digital filter, a kernel smoother, smoothing splines, or any other smoothing algorithm known to one of ordinary skill in the art. In some aspects, smoothing the PPG signal and/or its transform may include applying one or more smoothing algorithms more than once (e.g., applying a rectangular smooth twice, a rectangular smooth followed by a Laplacian smooth, etc.).

Process 400 may include applying a band-pass filter to the transformed and/or smoothed PPG signal to generate a filtered signal (step 408). In some aspects, the band-pass filter may attenuate or nullify the amplitude of the transformed signal outside a certain frequency range. For example, process 400 may band-pass the transformed signal to restrict the filtered signal to amplitudes within the 0.83-4.0 Hz frequency range (corresponding, for example, to 50-240 BPM). The disclosed embodiments may contemplate other types of frequencies ranges, such as 0.5-7.0 Hz. Process 400 may apply the band-pass filter via hardware (e.g., via switches, capacitors, resistors, and other circuitry in pulse rate device 110), and/or software (e.g., executing instructions with a processor) to create the desired effect.

In certain aspects, process 400 may include identifying local maxima in the transformed and/or filtered signal (step 410). Process 400 may identify local maxima in this signal numerically. For example, process 400 may numerically compute a first derivative of the input signal (e.g., the transformed/filtered PPG signal) and determine when the numerical derivative is equal to equal zero,

$$e . g . , \frac{d \hat{f} ( ξ )}{d ξ} = 0 ,$$

where \hat{f}(ξ) represents the input signal (which may be filtered) in frequency space. Process 400 may also approximate this step by finding regions in the first derivative that are approximately equal to zero,

$$e . g . , \vert \frac{d \hat{f} ( ξ )}{d ξ} \vert < ɛ ,$$

for some small value ε (e.g., 1%, 2%, etc., of the amplitude range of \hat{f}(ξ)). Process 400 may also numerically confirm that this point is a maximum (e.g., as opposed to a minimum) by numerically computing the second derivative of the input signal and ensuring that this value is negative,

$$\frac{{d}^{2} \hat{f} ( ξ )}{d {ξ}^{2}} < 0$$

Process 400 may determine local maxima using other processes known to those of ordinary skill in the art, such as finding regions when the first derivative of the input signal changes polarity from positive to negative.

In some embodiments, process 400 may conduct further signal enriching, such as ensuring that identified maxima are outside of a certain frequency range (e.g., 3 BPM) from each other to suppress potential noise artifacts. Process 400 may undertake other such routines consistent with the disclosed embodiments. For example, process 400 may suppress identified local maxima whose amplitude (in absolute or relative terms) falls below some predefined peak threshold. In other words, process 400 may limit the identified local maxima to those whose amplitude is equal to or exceeds the peak threshold. Process 400 may identify the set of peaks Π as the local maxima identified in step 410 (step 412). The disclosed embodiments may then use these identified peaks to conduct further processing a described herein (e.g., the processes described in connection with FIGS. 3 and 5-9).

FIG. 5 depicts a flowchart for an example process 500 for constructing a learning library consistent with the disclosed embodiments. The example process 500 may be implemented via hardware and/or software instructions on one or more of the components of environment 100 such as pulse rate device 110, external system 132, or any combination thereof. Moreover, in certain aspects, process 500 may occur or be implemented as a standalone process. In other embodiments, process 500 may take place in the context of other processes (e.g., the probabilistic pulse rate estimation process 300 described in connection with FIG. 3). Certain aspects of process 500 may be reordered, rearranged, repeated, omitted, supplemented, modified, or integrated into additional processes in ways consistent with the disclosed embodiments.

Example process 500 begins by measuring, receiving, and/or storing one or more sets of library signals, collectively S_{L}, to initiate training of the learning library (step 502). As described above, the learning library may be stored in memory and reflect aggregated data wherein sets of signals and/or other derived measures (e.g., classifiers) are associated with known, accurate pulse rates. Each set of library signals may include any signal consistent with the disclosed embodiments (e.g., a PPG signal, a location signal, a speed signal, a posture signal, etc.). Each set of library signals may also include a pulse rate signal indicating the user's true pulse rate \tilde{p} (e.g., or providing information sufficient to determine the user's true pulse rate, etc.). By way of example, the pulse rate signal may include one or more electrocardiogram (ECG, EKG, etc.) signals monitoring the user's heart activity. In this manner, process 500 may associate a known, accurate pulse rate \tilde{p} to a concurrently measured set of signals (e.g., and/or their signal profiles) from a set of sensors 114. In some aspects, process 500 may include storing several (e.g., dozens, hundreds, etc.) of such sets of library signals, each set of library signals and/or their associated profiles associated with a true pulse rate \tilde{p}. Each set of library signals may include the same types of signals, but such correspondence is not required.

In some embodiments, process 500 may include generating and/or storing a set of library classifiers C_{L} based on the data in the learning library (step 504). A library classifier c_{L} may represent some logical or mathematical combination of signals in a set of signals defining a characteristic correlating with the known pulse rate \tilde{p}. Each library signal may be weighted and/or transformed so that it accurately represents the feature it is classifying. For example, given a set of library signals X_{L} (e.g., the aggregation of which may form the aggregated set of library signals S_{L}), process 500 may define a library classifier c_{L} as a mathematical combination of component signal values x:

$${c}_{L} = {\sum }_{i} {ω}_{i} {x}_{i} ,$$

where ωᵢ is a signal weight applied to the i-th signal of X_{L} used to represent the library classifier. These weights (as well as the underlying expression for c_{L}) may be determined heuristically, empirically, or otherwise established by a computing system (e.g., based on a linear or nonlinear multivariate regression analysis). The determining of such weights is within the knowledge of one of ordinary skill the in art in light of the disclosed embodiments. Furthermore, the set of library signals X_{L} may reflect raw signals, time-averaged signals, transformed signals, smoothed signals, or any other type of signals consistent with the disclosed embodiments.

In some embodiments, process 500 may determine the values of the signal weights based on correlations between the library classifier(s) (as governed by a combination of signal inputs) and a known pulse rate \tilde{p}. For example, the values of the signal weights may be determined using a softmax function governing a set of normalized signals. In one aspect, the probability for the i-th class of a set of library classifiers X having K dimensions may be given by

$$p ( x = i \vert X ) = \frac{{e}^{{X}^{T} {Ω}_{i}}}{{\sum }_{k = 1}^{K} {e}^{{X}^{T} {Ω}_{k}}}$$

where T represents the transpose operator and Ω reflects the set of signal weights. The value of the signal inputs may be based on all or a subset of individuals from the data in the learning library.

Of course, those of ordinary skill in the art will appreciate that the foregoing expression of classifier c_{L} is merely exemplary. For example, the classifier c_{L} may instead be represented as a product of signals and their signal weights (e.g.,) c_{L}=Πᵢωᵢxᵢ), as a multivariate polynomial function wherein each signal has a corresponding signal weight and power (e.g., c_{L}=Σᵢωᵢxᵢ^{b}^{ᵢ}), some statistical analysis of the set of signals (e.g., a multivariable regression analysis), any combination of these considerations, etc. Thus, the library classifier may embody any function of a set of library signals, c_{L}=f(X_{L}), and the values of the signal weights may be governed in part by, for example, the softmax function.

In some embodiments, the set of functions and weights describing a library classifier may include a composite of the foregoing functions such that each is associated with its own signal weight(s). These signal weights may comprise the set of signal weights consistent with the disclosed embodiments. In such cases, the library classifier may be expressed as a series of nested function, each having their own expression and signal weights so that p(X)=f(X)=f₁(f₂( . . . fₙ(X))) for a set of library signals (here denoted X). Process 500 may generate the expressions and signal weights associated with these functions in the same manner described above. Additionally or alternatively, the values of the signal weights of the intermediate (hidden) functions may be determined using a sigmoid activation function

$$S ( ω ) = \frac{1}{1 + {e}^{- ω}}$$

and an L2 weight decay

$$L = {\sum }_{i} {ω}_{i}^{2}$$

to suppress large weight values. In addition, process 500 may implement a dropout fraction (e.g., 0.15) to prevent overfitting of the signal weights.

By way of example, process 500 may include using a neural network with two or three hidden layers in which each layer employs sigmoid activation functions to generate the signal weights, and the final output layer uses the softmax function to output the pulse rate likelihood. Process 500 may map a set of library classifiers in this fashion, and may further employ an L2 weight decay and a dropout fraction (e.g., 0.15) to prevent large and overfitting signal weights.

In another example, process 500 may define a posture classifier as a function of some combination of simultaneously-measured signals from a posture sensor, a gyroscope, an accelerometer, etc. Process 500 may then use this expression to determine the current posture of user 116 (e.g., prone, erect, sitting, etc.), based on the values of the input signals X_{L}. Process 500 may define one or more library classifiers c_{L} in this manner, each with its own set of weights, expressions, library signals X_{L}, etc., to generate a set of library classifiers C_{L}. For example, process 500 may define library classifiers comprising one or more of activity classifiers (e.g., reflecting a type of activity a user is engaging in, such as walking, running, standing, sitting, sleeping, etc.), harmonic classifiers (e.g., reflecting signal features or artifacts indicating the presence of harmonics in a PPG signal in frequency space), location classifiers (e.g., reflecting a current location of a user, such as a gym, a train, a highway, a home, an office, a particular geographical boundary, etc.), posture classifiers (e.g., reflecting the current posture of a user, such as prone, erect, leaning, sitting, reclining, etc.), waveform classifiers (e.g., reflecting features of a signal such as signal strength, peak amplitude and width, signal-to-noise ratio, the location and distribution of peaks and/or other morphologies, etc.), and other such classifiers consistent with the disclosed embodiments. By way of example, process 500 may determine define and/or determine the activity classifier based on a speed signal associated with a user (e.g., speeds within one range indicate negligible movement, walking movements, running movements, speeds exceeding running movements such as driving a car, etc.), a posture signal associated with the user (e.g., whether the user is erect or prone), and/or a location of the user (e.g., whether the user is located within a geographical region associated with a gym or fitness center, movie theater, etc.).

Process 500 may associate, for each set of library signals, each of the library classifiers to the known pulse rates \tilde{P} and/or their associated library signal(s) in the learning library (step 506). In some embodiments, this association may enable process 500 to determine a classification coefficient γ for each library classifier c_{L} in the set of library classifiers C_{L} (step 508). In certain aspects, for instance, the classification coefficient may reflect a degree or function of correlation between a library classifier the known pulse rates \tilde{P} across the learning library. The classification coefficient may thus reflect a level of correspondence or power of predictability between a library classifier and/or its value to a user's true pulse rate. In one example, for instance, this degree of correlation may be determined as a standard correlation measure, γ=corr(c_{L},\tilde{P}). Those of ordinary skill in the art will appreciate additional expressions for the classification coefficient consistent with the disclosed embodiments. Process 500 may iterate over every library classifier in this manner to generate a set of classification classifiers associated with the set of library signals S_{L} and/or library classifiers C_{L}.

In some aspects, a classification coefficient γ may depend on the type of classifier defined. For example, process 500 may define a classification coefficient for all types of a posture or activity classifier. In certain embodiments, the classification coefficient may also depend on the value of the classifier. For example, process 500 may determine different classification coefficients for activity classifiers having exemplary values of running, walking, reclining, sleeping, etc. These value-based classification coefficients may be based on the underlying classifier type (e.g., activity classifier), and/or may be derived independently using processes consistent with the disclosed embodiments.

Based on the computed classification coefficients Γ, the sets of library signals S_{L}, and/or the set library classifiers C_{L} (and their values), process 500 may construct models of pulse rates and pulse rate profiles (step 510). In some aspects, these models may define how the sets of library classifiers and/or library signals correspond to known pulse rates through the classification coefficients. The disclosed embodiments may employ these models, for example, to estimate the pulse rates of users in new circumstances based on new sets of signals and signal profiles, such as those described herein.

FIG. 6 depicts a flowchart for an example process 600 for determining a set of pulse rate likelihoods consistent with the disclosed embodiments. The example process 600 may be implemented via hardware and/or software instructions on one or more of the components of environment 100, such as pulse rate device 110, external system 132, or any combination thereof. Moreover, in certain aspects, process 600 may occur or be implemented as a standalone process. In other embodiments, process 600 may take place in the context of other processes (e.g., the probabilistic pulse rate estimation process 300 described in connection with FIG. 3). Certain aspects of process 600 may be reordered, rearranged, repeated, omitted, supplemented, modified, or integrated into additional processes in ways consistent with the disclosed embodiments.

The example process 600 begins by receiving, measuring, and/or detecting a set of sample signals from a set of sensors 114 (step 602). The respective sets of signals and sensors may comprise any suitable signal or sensor consistent with the disclosed embodiments. In some aspects, the set of sample signals may include a PPG signal measured with respect to user 116. The set of sample signals may further include other signals, such as position and posture signals, etc. The set of sensors may include an optical pulse rate sensor, such as those described herein, in addition to other sensors (e.g., a posture sensor, a gyroscope, and air pressure sensor, etc.).

Process 600 may include generating a set of sample classifiers C_{S} based on the set of sample signals (step 604). In some aspects, process 600 may generate the set of sample classifiers C_{S} in a manner similar to those for generating the set of library classifiers C_{L} described in reference to FIG. 5. For example, a sample classifier c_{S} may represent a logical or mathematical representation of signals in a set of sample signals S_{S}. This representation may reflect the same or similar representation used to determine the library classifiers C_{L} from library signals X_{L} having a known correlate to a known pulse rate \tilde{p}. For example, given a set of sample signals S_{S}, process 600 may define a sample classifier c_{S} as a mathematical combination of component signal values sⱼ:

$${c}_{s} = {\sum }_{j} {α}_{j} {s}_{j} ,$$

where αⱼ is a sample signal weight applied to the j-th sample signal of S_{S} used to represent the sample classifier c_{S}. In some aspects, this sample weight may be identical to that used to define the library classifier, αⱼ=ωᵢ and i=j, but such strict correspondence is not required (e.g., if one of the signals is not available or has a signal-to-noise ratio outside of acceptable limits). These sample weights (as well as the underlying expression for c_{S}) may be determined empirically or heuristically, and the determining of such weights is within the knowledge of one of ordinary skill the in art in light of the disclosed embodiments. Furthermore, the set of sample signals S_{S} may reflect raw signals, time-averaged signals, transformed signals, smoothed signals, or any other type of signals consistent with the disclosed embodiments.

As explained above, those of ordinary skill in the art will appreciate that the foregoing expression of classifier c_{S} is merely exemplary. For example, the classifier c_{S} may instead be represented as a product of sample signals and their sample signal weights (e.g., c_{S}=Πⱼαⱼsⱼ), as a multivariate polynomial function wherein each signal has a corresponding signal weight and power (e.g., c_{S}=Σⱼαⱼsⱼ^{b}^{ⱼ}), some statistical analysis of the set of sample signals (e.g., a multivariable regression analysis), any combination of these considerations, etc. Thus, the sample classifier may embody any function of a set of signals, c_{S}=f(S_{S}), where the function f need not be the same as the function defining the library classifiers. By way of example, process 600 may determine the value of a sample posture classifier based on some function of simultaneously-measured sample signals from a posture sensor, a gyroscope, an accelerometer, etc. Process 600 may then use this expression to estimate the current posture of user 116 (e.g., prone, erect, sitting, etc.), based on the values of the input signals S_{S}. Process 600 may define one or more sample classifiers c_{S} in this manner, each with its own set of sample weights, expressions, etc., to generate a set of sample classifiers C_{S}.

Process 600 may include comparing the generated set of sample classifiers C_{S} to a set of library classifiers C_{L} (step 606). The set of library classifiers C_{L} may be previously generated and/or stored within memory (e.g., on pulse rate device 110) or retrieved from other computing systems as needed (e.g., from an external system 132). In some aspects, this comparison may enable process 600 to determine a correspondence coefficient σ for each sample classifier c_{S} in the set of sample classifiers C_{S} (step 608). The correspondence coefficient σ may reflect a degree of correlation between a sample classifier c_{S} and a library classifier c_{L} defined in a learning library. In these embodiments, this correlation may reflect a degree of similarity between the one or more sample signals generating the sample classifier c_{S} compared with those used to create and/or define a corresponding library classifier c_{L}. In one example, for instance, this degree of correlation may be determined as a standard correlation measure, σ=corr(c_{S},c_{L}). Those of ordinary skill in the art will appreciate additional expressions for the correspondence coefficient consistent with the disclosed embodiments. Process 600 may iterate over every sample classifier in this manner to generate a set of correspondence classifiers associated with the set of sample signals S_{S} and/or sample classifiers C_{S}.

In certain aspects, process 600 may determine a set of pulse rate likelihoods P for each identified peak π in a set of identified peaks Π of a transformed PPG signal (step 610). These peaks may be identified using any process consistent with the disclosed embodiments (e.g., the peak identification processes described in reference to FIGS. 3 and 4). In some aspects, these pulse rate likelihoods may reflect the probability that a pulse rate vᵢ of an identified peak πᵢ in frequency space corresponds to the user's true pulse rate \tilde{p}. Process 600 may determine the set of pulse rate likelihoods P as a function of the pulse rate vᵢ associated with each peak πᵢ, the set of classification coefficients associated Γᵢ with the peak, and the set of correspondence coefficients Σᵢ associated with the peak, p(πᵢ)=f(vᵢ,Γᵢ,Σᵢ). In some aspects, process 600 may determine the set of pulse rate likelihoods P without computing or accounting for the set of correspondence coefficients Σ, p(πᵢ)=f(vᵢ,Γᵢ).

As indicated above, the set of library classifiers C_{L}, the set of sample classifiers C_{S}, the set of classification coefficients, and/or the set of correspondence coefficients may be based generated, determined, or otherwise based on the pulse rate vᵢ associated with each peak πᵢ of a transformed PPG signal. In these aspects, the disclosed embodiments may establish the necessary classifiers and coefficients on a per-peak basis. Process 600 may use these per-peak determinations to generate the pulse rate likelihoods p(πᵢ) for each identified peak.

By way of simple example, pulse rate device 110 may measure a sample PPG signal having peaks in the frequency domain at 60 BPM, 70 BPM, 140 BPM, and 210 PBM. Process 600 may compare this (raw, transformed, and/or filtered) signal to those of the learning library to determine, for instance, that the sample signal correlates highly with a set of library PPG signals and/or library classifiers (e.g., indicating a high correspondence coefficient value). The device may further determine that these library PPG signals and/or classifiers correlate highly with known pulse rates of 70 BPM (e.g., indicating a high classification coefficient value for a known pulse rate of 70 BPM). Given these parameters, process 600 may determine that the pulse rate likelihood for the peak at 70 BPM is more likely than the pulse rates at 60, 140, and 210 BPM. In addition, process 600 may incorporate several such metrics into its determinations, such as using additional classifiers and/or signals. In one embodiment, for instance, process 600 may determine, based on signals from sensors 114, that user 116 is in a prone or resting position, and has been for some duration of time. Such information may constitute a sample classifier c_{S}. Process 600 may correlate such information with library posture classifiers (c_{L}) in the learning library to determine, for example, that the pulse rates of 60 and 70 BPM are more likely than those of 140 BPM and 210 BPM (e.g., based on their classification coefficients). Process 600 may iterate over all sample signals and/or sample classifiers (e.g., activity classifiers, harmonic classifiers, position classifiers, location classifiers, etc.) in this fashion to continually modify and deduce the pulse rate likelihood for each identified peak in the transformed and/or filtered PPG signal. Process 600 may further generate values and identities for the appropriate classifiers and coefficients based on further processes consistent with the disclosed embodiments.

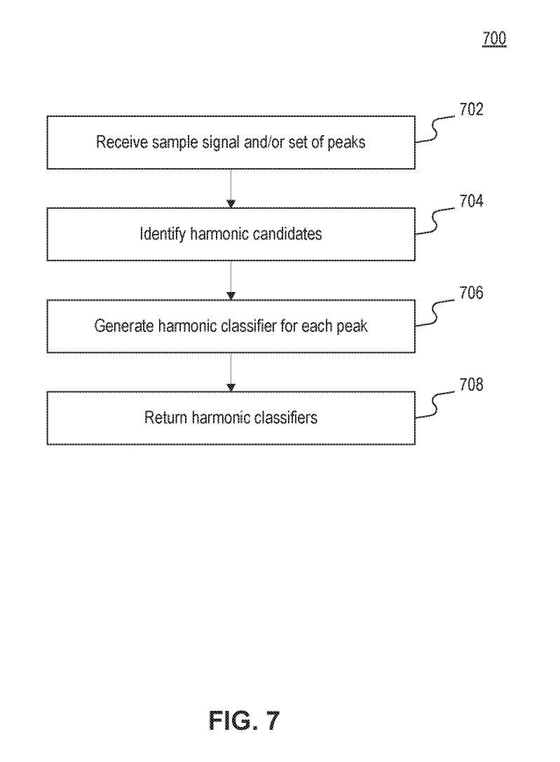

In some embodiments, the set of sample classifiers may include a harmonic classifier for each identified peak in a transformed PPG signal. FIG. 7 depicts a flowchart for an example process 700 for determining harmonic classifiers consistent with the disclosed embodiments. The example process 700 may be implemented via hardware and/or software instructions on one or more of the components of environment 100 such as pulse rate device 110, external system 132, or any combination thereof. Moreover, in certain aspects, process 700 may occur or be implemented as a standalone process. In other embodiments, process 700 may take place in the context of other processes. Certain aspects of process 700 may be reordered, rearranged, repeated, omitted, supplemented, modified, or integrated into additional processes in ways consistent with the disclosed embodiments.

Process 700 begins by receiving a PPG signal, a transformed PPG signal, or a determined set of peaks in a transformed signal (step 702). These signals and peaks may be handled and determined consistent with the disclosed embodiments (e.g., as described in connection with FIGS. 3 and 4). For example, process 700 may employ processes consistent with the disclosed embodiments to receive and/or determine a set of peaks Π in a transformed and/or band-pass filtered PPG signal, or any other type of PPG signal consistent with the disclosed embodiments.

In some aspects, process 700 may include identifying harmonic candidates for every identified peak π in the identified set of peaks Π in the input signal (step 704). In some embodiments, a harmonic candidate may reflect an identified peak or other signal artifact in the input signal reflecting a possible harmonic of a specific peak π in the set of peaks Π. These harmonic candidates may comprise, for example, peaks or other local maxima occurring at approximate integral multiples (e.g., expected harmonic values) of the subject peak in frequency space. For example, if process 700 identifies peaks and/or local maxima (e.g., using processes described in reference to FIG. 4) at frequencies of 60 BPM, 70 BPM, 120 BPM, 140 BPM, and 210 BPM, process 700 may determine that the peak at 120 BPM reflects a harmonic candidate for the peak at 60 BPM, and that the peaks at 140 BPM and 210 BPM are harmonic candidates of the peak at 70 BPM. Process 700 may identify further harmonic candidates based on small variances or approximations from such integral multiple peaks, such as those lying within a 1-2 BPM from the expected harmonic value. In one embodiment, for instance, process 700 may determine that a peak at 238 BPM is a harmonic candidate for a subject peak at 120 BPM.

Process 700 may include identifying and/or generating a harmonic classifier c_{S,h} for each peak π in the identified set of peaks Π (step 706). In some aspects, the harmonic classifier may be based on the number and/or strength (e.g., amplitude) of the detected harmonic candidates for peak π. In certain aspects, the harmonic classifier may also be based on the range of the band-pass filter applied to the underlying PPG signal. This consideration may account, for instance, for harmonic candidates potentially cut off or attenuated by the band-pass filter. For example, if the high-frequency range of the band-pass filter is 240 BPM, process 700 may weigh more significantly harmonic candidates occurring for peaks in the 61-80 BPM range (e.g., wherein a maximum of three harmonic candidates may appear, including a harmonic candidate at 240 BPM) than those appearing in the 49-60 range (e.g., wherein a maximum of four such harmonic candidates may appear). In certain aspects, for example, process 700 may determine these bounds and ranges by equally dividing the high-frequency cut-off by successively increasing integers and applying appropriate corrections.

In another example, the harmonic classifier may be based on the absence of a harmonic candidate where one would be expected if the peak represented the user's 116 true pulse rate. In this example, the absence or nonoccurrence of the harmonic candidate where one is expected may indicate that the identified subject peak is a result of random, pseudorandom, nonsignal, or irrelevant noise and not the user's pulse measurements. For example, process 700 may detect peaks in an input (transformed/filtered) signal at 60 BPM, 70 BPM, 140 BPM, and 210 BPM. Process 700 may determine that the peak at 70 BPM includes harmonic candidates at 140 BPM and 210 BPM. Process 700 may further determine that the input signal does not include peaks, local maxima, and/or harmonic candidates for the 60 BPM peak at expected harmonic locations (e.g., 120 BPM, 180 BPM, 240 BPM, etc.). In these aspects, process 700 may reflect these determinations in the harmonic classifiers associated with the peaks at 70 BPM and 60 BPM, respectively (e.g., by associating the harmonic classifier for the 70 BPM peak with a higher value, correspondence coefficient, classification coefficient, and/or other weight for pulse rate likelihood determinations). Using the foregoing processes and others disclosed herein, process 700 may include returning the determined harmonic classifiers for each peak to conduct further operations consistent with the disclosed embodiments (step 708).

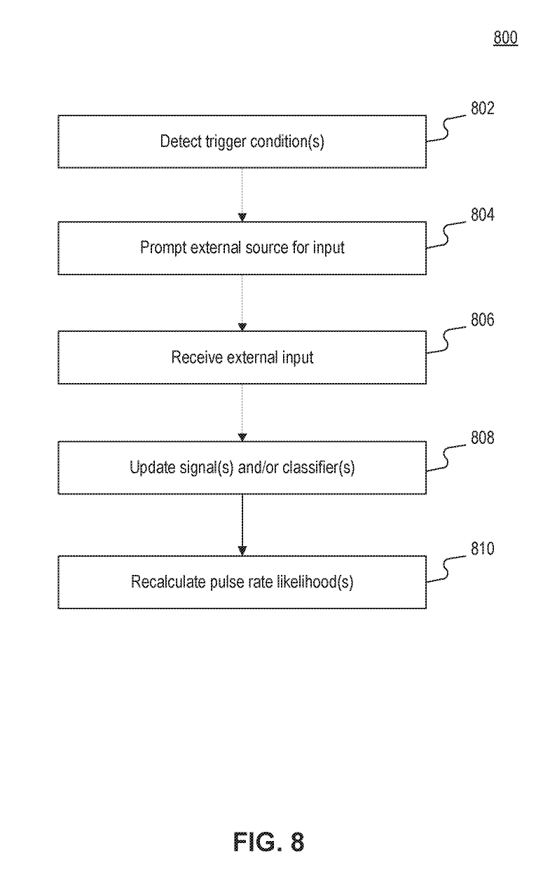

In some aspects, the disclosed embodiments may modify determined pulse rate likelihoods (e.g., as generated in processes described in connection with FIG. 6), correspondence coefficients and classification coefficients (e.g., as described in connection with the example embodiments of FIGS. 3, 5, and 6), sets of sample classifiers, and/or set of library classifiers based on input received from user 116. FIG. 8 depicts a flowchart for an example process 800 for incorporating external inputs consistent with the disclosed embodiments. The example process 800 may be implemented via hardware and/or software instructions on one or more of the components of environment 100 such as pulse rate device 110, external system 132, or any combination thereof. Moreover, in certain aspects, process 800 may occur or be implemented as a standalone process. In other embodiments, process 800 may take place in the context of other processes (e.g., the probabilistic pulse rate estimation process 300 described in connection with FIG. 3). Certain aspects of process 800 may be reordered, rearranged, repeated, omitted, supplemented, modified, or integrated into additional processes in ways consistent with the disclosed embodiments.

Process 800 begins by detecting the presence of one or more triggering condition(s) based on a set of sample signals received from a set of sensors 114 (step 802). A triggering condition may reflect a specific combination, value, and/or range of signals indicating the occurrence of a triggering event. A triggering event may reflect a real-world event having a known impact on expected pulse rates, classifier or coefficient values, or any other component of pulse rate likelihoods. Triggering conditions may be defined in a manner similar to those associated with library and/or sample classifiers, e.g., as linear combinations, logical combinations, polynomials, statistical analyses, etc. of the set of sample signals. The set of sample signals may reflect raw signals, signal values, time-averages signals, etc.

A triggering event may take any form consistent with the disclosed embodiments. In one example, for instance, a triggering event may reflect that user 116 and/or pulse rate device 110 is traveling at a rate of speed higher than some threshold, e.g., 30 MPH. In this example, the underlying triggering condition may reflect the function of signal values used to make this determination (e.g., based on GPS signals, accelerometer signals, time signals, etc.). The presence of these signals may indicate, for instance, that user 116 is more likely traveling in a vehicle (e.g., a car), than running or walking, which in turn may reduce pulse rate likelihoods for higher pulse rates because the user is not exercising. In this exemplary embodiment, process 800 or some other processes consistent with the disclosed embodiments may update a set of pulse rate likelihoods accordingly (e.g., by increasing the likelihood of lower pulse rates or those within a certain range, such as 60-80 BPM, and decreasing those in other range, such as 100-240 BPM). These adjustments may be done on a per-peak basis (e.g., based on empirical data in a learning library, other classifiers, etc.), or for all peaks within a given range.

The triggering event may also combine two types of triggering events and/or multiple signals. By way of example, process 800 may detect that a user's speed is below some threshold range (e.g., below 3 MPH, based on GPS/GNSS measurements and/or accelerometer signals). Process 800 may further detect that user 116 is present within a geographical range (e.g., based on a location signal, such as a GPS/GNSS sensor), such as one associated with a gym or fitness center. In this example, process 800 may adjust the calculated pulse rate likelihoods to reflect higher pulse rates expected for user 116, despite having a low speed (e.g., because the user is likely on a treadmill, lifting weights, etc.). These adjustments may take the form similar to those described above (e.g., increasing the pulse rate likelihood for peaks within certain ranges based on, for example, empirical data in a learning library).

In another example, process 800 may suppress peaks in a raw, transformed, or filtered PPG signal due to artifacts associated with a user's travel. In some aspects, artifacts associated with a user's travel may be caused by, for instance, gaps in sidewalks, a user's footsteps, breaks in road segments, train tracks, etc. In this example, process 800 may detect that user 116 is traveling at a particular speed, e.g., based on GPS signals over time. Process 800 may further identify peaks in a transformed PPG signal that are approximate integer factors or multiples of the determined speed over time-averaged intervals of the PPG signal (e.g., within a 1-3 BPM). This identification may assume, for instance, that noise artifacts in the PPG signal are distributed roughly uniformly over short time scales (e.g., they occur at approximately equally-spaced intervals). In such a regime, the frequency of such noise artifacts may be represented by fₐ=v/d, where f is the frequency of the noise artifact, v is the speed of user 116, and d is the distance between the physical constructs generating the noise artifacts (e.g., the length between sidewalk gaps, a user's stride length, etc.). Such noise artifacts may also generate noise harmonics in the transformed PPG signal that addressable with further processing (e.g., by removing integral harmonics of identified artifacts, fₐ=nv/d). In some aspects, process 800 may further determine that a user is within a prescribed geographic boundary (e.g., on a road, on a sidewalk, within a region associated with train tracks, etc., based on GPS signals). Such an example combination of signals may indicate that the identified peaks residing at locations within multiples or factors of the user's speed in the time-averaged signal may arise from artifacts associated with the user's travel. Upon detecting the noisy peaks in the transformed PPG signal that are multiples or factors of the user's time-averaged speed, process 800 may include suppressing these peaks in the frequency domain, the time domain, and/or reducing the pulse rate likelihood for the impacted peaks using processes consistent with the disclosed embodiments. Process 800 may also undertake other types of operations consistent with the disclosed embodiments (e.g., modifying correspondence and/or classifier values, etc.).

For example, process 800 may determine that a user is traveling at a speed of 60 MPH. In this example, suppose the user is traveling in a train over noise-creating constructs (e.g., train track railings) spaced 88 feet apart. Such constructs may generate noise artifacts at approximately 1 Hz in frequency space, in addition to possible harmonics. Process 800 may further determine that the transformed PPG signal as peaks at 60 BPM, among other peaks. In this example, process 800 may determine that a trigger condition has been met because a peak in the transformed PPG signal correspondence to an integer multiple or factor of the user's known speed. Using these determinations, process 800 may adjust the set of signals, the set of sample classifiers and/or their values, the values of correspondence or classification coefficients, or any other parameter of the pulse rate likelihoods accordingly.

In some aspects, process 800 may prompt a user for input in response to detecting a triggering condition, in addition to or in lieu of automatically recalculating the set of pulse rate likelihoods P (step 806). In some embodiments, the provided prompt may request the user to confirm, deny, or otherwise provide information assisting process 800 in interpreting the detection of triggering condition. Such information may include, for instance, a request for user 116 to confirm information associated with the user's location, speed, posture, travel, activity, or any other information consistent with the disclosed embodiments. The contemplated prompts may take any form and comprise any type of message suitable for providing and receiving information, such as an interface displayed on a smartphone, a push notification, a text message, etc. Process 800 may transmit the prompt via any computing system consistent with the disclosed embodiments, such as pulse rate device 110, an external system 132 associated with a user, etc. Process 800 may use external input from user 116 responsive to the prompt to conduct further processing consistent with the disclosed embodiments.

Upon receiving input from user 116, process 800 may include updating signal(s) and/or classifier(s), (steps 808). This updating process may include, for instance, adjusting the raw, transformed, or filtered PPG signal as described above (e.g., to suppress travel artifacts). This updating process may also include adjusting one or more other types of signals in this manner (e.g., adjusting speed signals, posture signals in response to a user's confirming her posture, etc.). Additionally or alternatively, process 800 may include updating a determined set of pulse rate likelihoods in response to the user's input using processes consistent with the disclosed embodiments (step 810). For example, process 800 may increase or decrease pulse rate likelihoods lying within some frequency range based on the user's confirming of an activity, posture, speed, location, etc.

FIG. 9 depicts a flowchart for an example process 900 for incorporating user libraries and classifiers consistent with the disclosed embodiments. The example process 900 may be implemented via hardware and/or software instructions on one or more of the components of environment 100, such as pulse rate device 110, external system 132, or any combination thereof. Moreover, in certain aspects, process 900 may occur or be implemented as a standalone process. In other embodiments, process 900 may take place in the context of other processes (e.g., the probabilistic pulse rate estimation process 300 described in connection with FIG. 3). Certain aspects of process 900 may be reordered, rearranged, repeated, omitted, supplemented, modified, or integrated into additional processes in ways consistent with the disclosed embodiments.

Process 900 begins by receiving a set of pulse rate likelihoods P, such as those determined consistent with the processes described in connection with FIGS. 3 and 6 (step 902). Each pulse rate likelihood p(πᵢ) may be associated with an identified peak π in a transformed, filtered PPG signal associated with user 116. In some aspects, process 900 may include comparing each pulse rate likelihood p(πᵢ) to a threshold (e.g., a user classification threshold). In some embodiments, the user classification threshold may be equal to and/or greater than the pulse likelihood threshold(s) described in connection with FIG. 3.

If none of the pulse rate likelihoods exceed the user classification threshold (step 906; no), process 900 may terminate to enable the disclosed embodiments to conduct further processing (e.g., such as the processes described in connection with FIGS. 3-8) (step 908). For example, process 900 may terminate and the disclosed embodiments, (e.g., implemented on pulse rate device 110), may initiate process 300 by receiving a set of signals from a set of sensors 114.

If one or more pulse rate likelihoods exceed the user classification threshold (step 906; yes), process 900 may update the learning library and/or a defined user classifier for use in further processing (step 910). In some aspects, updating the learning library may comprise adding the set of signals, classifiers, coefficients, and the pulse rate(s) associated with the peaks having a pulse rate likelihood exceeding the user classification threshold. Process 900 may associate the set of signals to all pulse rate(s) exceeding the user classification threshold in this manner or may limit such association to the pulse rate corresponding to the most likely peak. By including the set of signals and its associated pulse rate to the learning library, process 900 may thus incorporate signal profiles and metrics specific to user 116 into the library so that, over time, the learning library adjusts to the user's specific body mechanisms, routines, and other idiosyncrasies. This process may enable the learning library to become unique to user 116.

In some embodiments, process 900 may also update a user classifier in addition to or in lieu of updating the learning library. In certain aspects, the user classifier may reflect a library classifier reflecting a user's historic pulse rate profiles and unique characteristics correlating with known (or highly likely) pulse rates. The user classifier may be used where any library classifier occurs consistent with the disclosed embodiments. The user classifier may therefore enable the set of library classifiers C_{L} to reflect not only those signals from the initial training set, but also library classifications specific to user 116.

In some aspects, updating the learning library and/or updating the user classifier may include generating, updating, or otherwise recalibrating a classification coefficient associated with the user classifier and/or the sets of library sets S_{L} (step 912). For example, process 900 may add the set of signals, classifiers, etc. e.g., and their associated pulse rate to the learning library. The introduction of such a data set may alter the correlations between, e.g., each of the library classifiers c_{L} and the signal sets X_{L}, their corresponding classification coefficients γ, etc. These parameters may in turn affect subsequent sample classifiers c_{S} and their correspondence coefficients σ. Process 900 may recalculate all of the library classifiers, their classification coefficients, and any other metric using the foregoing embodiments (e.g., using processes described in connection with the example embodiments herein, such as that of FIGS. 3, 5 and 6). In this manner, process 900 may update the learning library to account for sets of signals and pulse rates specific to user 116 for use in subsequent calculations. Over time, the learning library may thus reflect measurements and signal profiles unique to the user, improving the accuracy and validity of estimated pulse rates. Once process 900 has updated the learning library and recalibrated its corresponding parameters (e.g., classifiers, classification coefficients, etc.), process 900 may terminate (step 908) to enable for further processing consistent with the disclosed embodiments.

The foregoing description has been presented for purposes of illustration. It is not exhaustive and is not limited to precise forms or embodiments disclosed. Modifications and adaptations of the embodiments will be apparent from consideration of the specification and practice of the disclosed embodiments. For example, the described implementations include hardware and software, but systems and methods consistent with the present disclosure can be implemented as hardware alone.

Computer programs based on the written description and methods of this specification are within the skill of a software developer. The various programs or program modules can be created using a variety of programming techniques. For example, program sections or program modules can be designed in or by means of Java, C, C++, assembly language, or any such programming languages. One or more of such software sections or modules can be integrated into a device system or existing communications software.

Moreover, while illustrative embodiments have been described herein, the scope includes any and all embodiments having equivalent elements, modifications, omissions, combinations (e.g., of aspects across various embodiments), adaptations and/or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps and/or inserting or deleting steps.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur to those skilled in the art, it is not desired to limit the disclosure to the exact construction and operation illustrated and described, and accordingly, all suitable modifications and equivalents may be resorted to, falling within the scope of the disclosure.

Other embodiments will be apparent to those skilled in the art from consideration of the specification and practice of the embodiments disclosed herein. It is intended that the specification and examples be considered as example only, with a true scope and spirit of the disclosed embodiments being indicated by the following claims.

What is claimed:

1. A method for probabilistically estimating an individual's pulse rate, the method comprising the following operations performed via one or more processors of a device:
receiving a set of signals from a set of sensors associated with a device worn by the individual, the set of signals including a photoplethysmographic (PPG) signal obtained from the individual;
transforming the PPG signal to the frequency domain;
applying a band-pass filter to the transformed signal to generate a filtered signal,
identifying a set of one or more peaks in the filtered signal, wherein a peak reflects a local maximum whose amplitude exceeds a threshold;
generating a set of one or more sample classifiers for each peak in the set of one or more peaks, the set of sample classifiers including a harmonic classifier;
comparing the set of sample classifiers to a set of library classifiers included in a learning library to identify a set of one or more classification coefficients respectively corresponding to the set of one or more peaks that respectively correspond to the set of one or more sample classifiers, wherein each library classifier is associated with a classification coefficient reflecting a degree of correlation between the library classifier and a known pulse rate profile; and
determining, based on one or more pulse rates respectively corresponding to the set of one or more peaks and the set of one or more classification coefficients, a set of one or more pulse rate likelihoods respectively corresponding to the set of one or more peaks.

2. The method of claim 1, wherein generating a set of one or more sample classifiers comprises applying a mathematical function to the set of one or more peaks.

3. The method of claim 2, wherein the mathematical function includes at least one of a sum of weighted components of the set of one or more peaks, a product of weighted components of the set of one or more peaks, a multivariate polynomial function where each peak in the set of one or more peaks has a corresponding weight and power, or a statistical analysis of the set of one or more peaks.

4. The method of claim 1, wherein the set of sample classifiers includes an activity classifier, wherein each sample classifier is associated with a correspondence coefficient reflecting a degree of correlation between the sample classifier and a library classifier in the set of library classifiers, and wherein the pulse rate likelihood is further based on the set of classification coefficients.

5. The method of claim 4, further comprising:
identifying a most likely pulse rate based on a highest pulse rate likelihood among the set of pulse rate likelihoods; and
determining whether the highest pulse rate likelihood exceeds a pulse likelihood threshold.

6. The method of claim 5, further comprising:
comparing the highest pulse rate likelihood to a user classification threshold greater than the pulse likelihood threshold; and
updating the learning library to include the set of measured signals and the most likely pulse rate as a known pulse rate profile when the highest pulse rate likelihood exceeds the user classification threshold.

7. The method of claim 6, further comprising, when the highest pulse rate likelihood exceeds the user classification threshold:
updating the set of library classifiers based on the set of sample classifiers; and
updating the set of classification coefficients by recalculating the degree of correlation between the set of library classifiers and the known pulse rate profiles.

8. The method of claim 1, further comprising:
detecting an occurrence of a trigger condition based on the set of signals;
prompting the individual for input responsive to detecting the trigger condition;
receiving input responsive to the prompt; and
updating at least one pulse rate likelihood based on the received input.

9. The method of claim 8, wherein detecting the occurrence of a trigger condition further comprises:
determining a speed associated with the individual; and
determining that at least one identified peak corresponds to a time-averaged pulse rate that is an approximate integer factor or multiple of the speed.

10. The method of claim 1, further comprising identifying, for each identified peak, a set of harmonic candidates in the transformed signal, and wherein the harmonic classifier is based on a number and amplitude of each of the harmonic candidates.

11. A system for probabilistically estimating an individual's pulse rate, the system comprising:
a memory storing instructions; and
one or more processors configured to execute the instructions to perform one or more operations, the operations comprising:
receiving a set of signals from a set of sensors associated with a device worn by the individual, the set of signals including a photoplethysmographic (PPG) signal obtained from the individual;
transforming the PPG signal to the frequency domain;
applying a band-pass filter to the transformed signal to generate a filtered signal;
identifying a set of one or more peaks in the filtered signal, wherein a peak reflects a local maximum whose amplitude exceeds a threshold;
generating a set of one or more sample classifiers for each peak in the set of one or more peaks, the set of sample classifiers including a harmonic classifier;
comparing the set of sample classifiers to a set of library classifiers included in a learning library, each library classifier being associated with a classification coefficient reflecting a degree of correlation between the library classifier and a known pulse rate profile;
determining, based on one or more pulse rates respectively corresponding to the set of one or more peaks and the set of one or more classification coefficients, a set of one or more pulse rate likelihoods respectively corresponding to the set of one or more peaks.

12. The system of claim 11, wherein the operation of generating a set of one or more sample classifiers comprises applying a mathematical function to the set of one or more peaks.

13. The method of claim 12, wherein the mathematical function includes at least one of a sum of weighted components of the set of one or more peaks, a product of weighted components of the set of one or more peaks, a multivariate polynomial function where each peak in the set of one or more peaks has a corresponding weight and power, or a statistical analysis of the set of one or more peaks.

14. The system of claim 11, wherein the set of sample classifiers includes an activity classifier, wherein each sample classifier is associated with a correspondence coefficient reflecting a degree of correlation between the sample classifier and a library classifier in the set of library classifiers, and wherein the pulse rate likelihood is further based on the set of classification coefficients.

15. The system of claim 14, further comprising:
identifying a most likely pulse rate based on a highest pulse rate likelihood among the set of pulse rate likelihoods; and
determining whether the highest pulse rate likelihood exceeds a pulse likelihood threshold.

16. The system of claim 15, further comprising:
comparing the highest pulse rate likelihood to a user classification threshold greater than the pulse likelihood threshold; and
updating the learning library to include the set of measured signals and the most likely pulse rate as a known pulse rate profile when the highest pulse rate likelihood exceeds the user classification threshold.

17. The system of claim 16, further comprising, when the highest pulse rate likelihood exceeds the user classification threshold:
updating the set of library classifiers based on the set of sample classifiers; and
updating the set of classification coefficients by recalculating the degree of correlation between the set of library classifiers and the known pulse rate profiles.

18. The system of claim 11, further comprising:
detecting an occurrence of a trigger condition based on the set of signals;
prompting the individual for input responsive to detecting the trigger condition;
receiving input responsive to the prompt; and
updating at least one pulse rate likelihood based on the received input.

19. The system of claim 18, wherein detecting the occurrence of a trigger condition further comprises:
determining a speed associated with the individual; and
determining that at least one identified peak corresponds to a time-averaged pulse rate that is an approximate integer factor or multiple of the speed.

20. The system of claim 11, further comprising identifying, for each identified peak, a set of harmonic candidates in the transformed signal, and wherein the harmonic classifier is based on a number and amplitude of each of the harmonic candidates.

21. A tangible, non-transitory computer-readable medium storing instructions, that, when executed by at least one processor, cause the at least one processor to perform operations for probabilistically estimating a pulse rate in the presence of nontrivial noise, the method comprising:
receiving a set of signals from a set of sensors associated with a device worn by an individual, the set of signals including a photoplethysmographic (PPG) signal obtained from the individual;
transforming the PPG signal to the frequency domain;
applying a band-pass filter to the transformed signal to generate a filtered signal,
identifying a set of one or more peaks in the filtered signal, wherein a peak reflects a local maximum whose amplitude exceeds a threshold;
generating a set of one or more sample classifiers for each peak in the set of one or more peaks, the set of sample classifiers including a harmonic classifier;
comparing the set of sample classifiers to a set of library classifiers included in a learning library, each library classifier being associated with a classification coefficient reflecting a degree of correlation between the library classifier and a known pulse rate profile;
determining, based on one or more pulse rates respectively corresponding to the set of one or more peaks and the set of one or more classification coefficients, a set of one or more pulse rate likelihoods respectively corresponding to the set of one or more peaks.

22. The computer-readable medium of claim 21, wherein generating a set of one or more sample classifiers comprises applying a mathematical function to the set of one or more peaks.

23. The computer-readable medium of claim 22, wherein the mathematical function includes at least one of a sum of weighted components of the set of one or more peaks, a product of weighted components of the set of one or more peaks, a multivariate polynomial function where each peak in the set of one or more peaks has a corresponding weight and power, or a statistical analysis of the set of one or more peaks.

24. The computer-readable medium of claim 21, wherein the set of sample classifiers includes an activity classifier, wherein each sample classifier is associated with a correspondence coefficient reflecting a degree of correlation between the sample classifier and a library classifier in the set of library classifiers, wherein the pulse rate likelihood is further based on the set of classification coefficients, and wherein the method further comprises identifying a most likely pulse rate based on a highest pulse rate likelihood among the set of pulse rate likelihoods and determining whether the highest pulse rate likelihood exceeds a pulse likelihood threshold.

25. The computer-readable medium of claim 24, wherein the operations performed by the at least one processor further comprises comparing the highest pulse rate likelihood to a user classification threshold greater than the pulse likelihood threshold, and, when the highest pulse rate likelihood exceeds the user classification threshold:
updating the learning library to include the set of measured signals and the most likely pulse rate as a known pulse rate profile;
updating the set of library classifiers based on the set of sample classifiers; and
updating the set of classification coefficients by recalculating the degree of correlation between the set of library classifiers and the known pulse rate profiles.

26. The computer-readable medium of claim 21, wherein the operations performed by the at least one processor further comprises:
detecting an occurrence of a trigger condition based on the set of signals by determining a speed associated with the user and determining that at least one identified peak corresponds to a time-averaged pulse rate that is an approximate integer factor or multiple of the speed;
prompting the individual for input responsive to detecting the trigger condition;
receiving input responsive to the prompt; and
updating at least one pulse rate likelihood based on the received input.
